(19) United States
(12) Patent Application Publication
(10) Pub. No.: US 2025/0031620 A1
(43) Pub. Date: Jan. 30, 2025

(54) COTTON STRIPPER AIR DUCT SYSTEM

(71) Applicant: Deere & Company, Moline, IL (US)

(72) Inventors: Jeffrey S. WIGDAHL, Ames, IA (US); Marcus A. JACOBSON, Ankeny, IA (US)

(73) Assignee: Deere & Company, Moline, IL (US)

(21) Appl. No.: 18/771,321

(22) Filed: Jul. 12, 2024

Related U.S. Application Data
(60) Provisional application No. 63/516,326, filed on Jul. 28, 2023.
(60) Provisional application No. 63/516,318, filed on Jul. 28, 2023.
(60) Provisional application No. 63/516,299, filed on Jul. 28, 2023.

(51) Int. Cl. A01D 46/10

(52) U.S. Cl. CPC A01D 46/10

(57) ABSTRACT

One or more techniques and/or systems are disclosed for harvesting cotton that includes an air duct for a cotton stripper having a first portion having a rear separation duct panel configured to separate non-cotton material from cotton material, wherein the rear separation duct has a planar lower wall. The air duct further includes a second portion movably coupled to the first portion, wherein the second portion has an opening configured as an inlet that receives the cotton material and the non-cotton material, and the second portion has an open floor portion. The planar lower wall of the rear separation duct panel extends to overlap with at least part of the open floor portion.

### CROSS-REFERENCE TO RELATED APPLICATIONS

The present application is based on and claims the benefit of U.S. Provisional Patent application Ser. No. 63/516,318, filed Jul. 28, 2023, entitled COTTON STRIPPER AIR DUCT SYSTEM, Docket Number (016529-000168/P34701-US-PRO), Ser. No. 63/516,326, filed Jul. 28, 2023, entitled COTTON STRIPPER AIR DUCT SYSTEM, Docket Number (016529-000170/P34781-US-PRO), and Ser. No. 63/516,299, filed Jul. 28, 2023, entitled COTTON STRIPPER AIR SUPPLY SYSTEM, Docket Number (016529-0166/P34494-US-PRO), the contents of each of which are hereby incorporated by reference herein in their entirety.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for harvesting crop at a higher flow rate while still removing unwanted or non-desired materials. In one implementation, an air duct for a cotton stripper comprises a first portion having a rear separation duct panel configured to separate non-cotton material from cotton material, wherein the rear separation duct panel has a planar lower wall. The air duct further comprises a second portion movably coupled to the first portion, wherein the second portion has an opening configured as an inlet that receives the cotton material and the non-cotton material, and the second portion has an open floor portion. The planar lower wall of the rear separation duct panel extends to overlap with at least part of the open floor portion.

In an implementation, an air duct for a cotton stripper comprises a first portion having a rear separation duct panel configured to separate non-cotton material from cotton material, wherein the rear separation duct panel has a planar lower wall. The air duct further comprises a second portion movably coupled with the first portion at a joint forming a gap between the first and second portions, wherein the second portion has an opening configured as an inlet that receives the cotton material and the non-cotton material into the air duct, wherein the second portion has a planar lower wall extending from the joint forming the gap between the first and second portions to the opening configured as the inlet, wherein a forward extent of the planar lower wall of the first portion ends at the gap between the first and second portions without overlapping the planar lower wall of the second portion. In any of the examples, the gap is provided between the first portion and the second portion that allows, in part, movement between the first portion and the second portion (e.g., the second portion pivots with respect to the first portion to be oriented towards the ground). In accordance with any of the examples, the planar lower wall of the first portion is pivotally connected on a first end thereof with the rear separation duct panel, wherein pivoting a second end of the planar lower wall of the first portion opposite the first end thereof in a direction away from the gap at the joint provides an expulsion opening configured to permit the non-cotton material separated from the cotton material to be expelled from the air duct and to permit air to enter into the air duct. In accordance with any of the examples, the planar lower wall of the second portion is substantially planar and without protuberances extending into the air duct. In accordance with any of the examples, the planar lower walls of the first and second portions are substantially planar, wherein the first and second planar lower walls of the first and second portions lic in a common plane for the second end of the planar lower wall of the first portion disposed in a direction towards the gap between the first and second portions.

In an implementation, an air duct for a cotton stripper comprises a first portion having a rear separation duct panel configured to separate non-cotton material from cotton material, wherein the rear separation duct panel has a planar lower wall. The air duct further comprises a second portion movably coupled with the first portion at a joint forming a gap between the first and second portions, wherein the second portion has an opening configured as an inlet that receives the cotton material and the non-cotton material into the air duct, wherein the second portion has a planar lower wall extending from the joint forming the gap between the first and second portions to an open floor portion that begins at a forward extent of the planar lower wall of the second portion. In accordance with any of the examples, the planar lower wall of the second portion is pivotally connected on a first end thereof with the second portion, wherein pivoting a second end of the planar lower wall of the second portion opposite the first end thereof in a direction away from the second portion provides a first expulsion opening configured to permit the non-cotton material separated from the cotton material to be expelled from the air duct. In accordance with any of the examples, the planar lower wall of the first portion is pivotally connected on a first end thereof with the rear separation duct panel, wherein pivoting a second end of the planar lower wall of the first portion opposite the first end thereof in a direction away from the joint forming the gap provides a second expulsion opening configured to permit the non-cotton material separated from the cotton material to be expelled from the air duct and to permit air to enter into the air duct.

In an implementation, an air duct for a cotton stripper comprises a first portion having a rear separation duct panel configured to separate non-cotton material from cotton material, wherein the rear separation duct panel has a planar lower wall. The air duct further comprises a second portion movably coupled with the first portion at a joint forming a gap between the first and second portions, wherein the second portion has an opening configured as an inlet that receives the cotton material and the non-cotton material into the air duct, wherein the second portion has a planar lower wall extending from the joint forming the gap between the first and second portions to an open floor portion that begins at a forward extent of the planar lower wall of the second portion. In accordance with any of the examples, the planar lower wall of the second portion carries a crop deflection member extending from the planar lower wall of the second portion in a direction away from the second portion, wherein the crop deflection member is configured to provide a barrier to entry of associated crop and miscellaneous other materials into the open floor portion of the second portion for relative movement between the air duct and the associated crop in a direction of the crop deflection member leading the open floor portion towards the associated crop. In accordance with any of the examples, the planar lower wall of the second portion is pivotally connected on a first end thereof with the second portion, wherein pivoting a second end of the planar lower wall of the second portion opposite the first end thereof in a direction away from the second portion provides a first expulsion opening configured to permit the non-cotton material separated from the cotton material to be expelled from the air duct. In accordance with any of the examples, the planar lower wall of the first portion is pivotally connected on a first end thereof with the rear separation duct panel, wherein pivoting a second end of the planar lower wall of the first portion opposite the first end thereof in a direction away from the joint provides a second expulsion opening configured to permit the non-cotton material separated from the cotton material to be expelled from the air duct and to permit air to enter into the air duct.

In an implementation, an air duct for a cotton stripper comprises a first portion having a rear separation duct panel configured to separate non-cotton material from cotton material, wherein the rear separation duct panel has a planar lower wall. The air duct further comprises a second portion movably coupled with the first portion at a joint forming a gap between the first and second portions, wherein the second portion has an opening configured as an inlet that receives the cotton material and the non-cotton material into the air duct, wherein the second portion has a planar lower wall extending from the joint forming the gap between the first and second portions to an open floor portion that begins at a forward extent of the planar lower wall of the second portion. In accordance with any of the examples, the planar lower wall of the second portion carries an arcuate crop shield member extending from the planar lower wall of the second portion in a direction away from the second portion, wherein the arcuate crop shield member is configured to permit the non-cotton material separated from the cotton material to be expelled from the air duct, together with any other debris entering the inlet and entrained in the air flow carrying the cotton and non-cotton material. In accordance with any of the examples, the arcuate crop shield member also provides a barrier to entry of associated crop into the open floor portion of the second portion for relative movement between the air duct and the associated crop in a direction of the arcuate crop shield member leading the open floor portion towards the associated crop. In accordance with any of the examples, the planar lower wall of the second portion is pivotally connected on a first end thereof with the second portion, wherein pivoting a second end of the planar lower wall of the second portion opposite the first end thereof in a direction away from the second portion provides a first expulsion opening configured to permit the non-cotton material separated from the cotton material to be expelled from the air duct. In accordance with any of the examples, the planar lower wall of the first portion is pivotally connected on a first end thereof with the rear separation duct panel, wherein pivoting a second end of the planar lower wall of the first portion opposite the first end thereof in a direction away from the joint provides a second expulsion opening configured to permit the non-cotton material separated from the cotton material to be expelled from the air duct and to permit air to enter into the air duct.

In another implementation, a harvester vehicle comprises a header system that includes a crop header component, wherein the crop header components comprises a cotton stripper header. The harvester vehicle further comprises an air system operably coupled to, and in communication with, the header system. The air system includes a crop conveyor component that conveys crop through the harvester vehicle, wherein the crop conveyor component includes one or more air ducts having a cotton stripper lower transition duct with a rear separation duct panel having a planar lower wall that overlaps with an open floor portion of an inlet of the lower transition duct.

In another implementation, a method for configuring a lower transition duct in a cotton stripper comprises configuring a rear separation duct panel to have a planar lower wall and configuring a cotton inlet to have an open floor portion, wherein the cotton inlet is capable of receiving cotton material and non-cotton material. The method further includes arranging the rear separation duct panel and the cotton inlet such that the planar lower wall of the rear separation duct panel extends to overlap with at least part of the open floor portion.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The examples disclosed herein may take physical form in certain parts and arrangement of parts, and will be described in detail in this specification and illustrated in the accompanying drawings which form a part hereof and wherein:

FIG. 1 is a component diagram illustrating a perspective view of a harvester vehicle having a cotton stripper according to an implementation.

FIG. 2 is a component diagram illustrating an airflow system with a lower transition duct configured according to an implementation.

FIG. 3 is a diagram illustrating a lower transition duct configured according to an implementation.

FIG. 5 is a diagram illustrating a lower transition duct having protruding members according to an implementation.

FIG. 6 is a diagram illustrating a floor piece of a lower transition duct configured according to an implementation.

FIG. 7 is a diagram illustrating a portion of a lower transition duct configured according to an implementation.

FIG. 8 is a diagram illustrating a bottom portion of a lower transition duct configured according to an implementation.

FIG. 9 is a component diagram illustrating an airflow system with a lower transition duct configured according to an implementation.

FIG. 10 is a component diagram illustrating an airflow system with a lower transition duct configured according to an implementation.

FIG. 11 is a component diagram illustrating an airflow system with a lower transition duct configured according to an implementation.

FIG. 12 is a component diagram illustrating an airflow system with a lower transition duct configured according to an implementation.

FIG. 12A is a component diagram illustrating an airflow system with a lower transition duct configured according to an implementation.

FIG. 13 is a diagram illustrating a seal according to an implementation.

FIG. 14 is a diagram illustrating another seal according to an implementation.

FIG. 15 illustrates an example of a method for configuring a lower transition duct in a cotton stripper according to an implementation.

FIG. 16 is a block diagram of an example computing environment suitable for implementing various examples.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The methods and systems disclosed herein, for example, may be suitable for use in different harvesters and harvesting applications. That is, the herein disclosed examples can be implemented in different harvesters other than for particular types of crops and/or harvesting systems (e.g., other than for specific farm harvester vehicles for particular harvesting applications, such as the herein described cotton harvester).

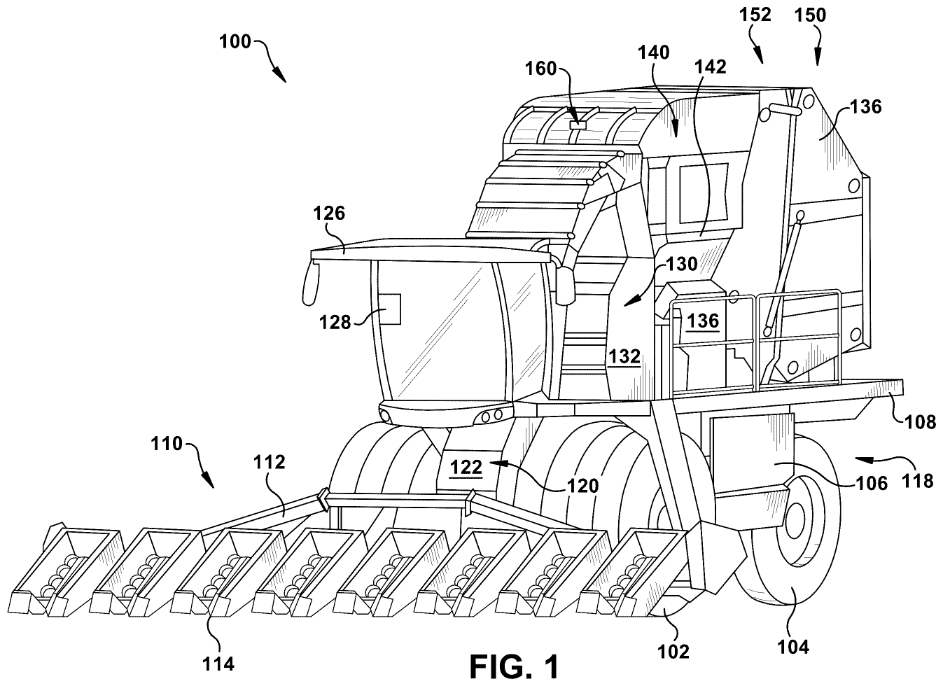

FIG. 1 illustrates an example harvester vehicle 100 that can utilize one or more portions of the aspects and examples described herein to harvest cotton. In this example, the harvester vehicle 100 is a cotton harvester with a cotton stripper, but other types of harvesters are contemplated by this disclosure.

The harvester vehicle 100 includes a chassis 108 that is supported by front wheels 102 and rear wheels 104, although other support is contemplated, such as tracks. A power module 118, such as an engine 106, is supported below the chassis 108 in the illustrated example. Water, lubricant, and fuel tanks (not shown) can be supported in and on the chassis 108. The harvester vehicle 100 is adapted for movement through a field to harvest crops, such as cotton in one or more examples.

An operator station 126 is also supported by the chassis 108. An operator interface 128 is positioned in the operator station 126. In some examples, the operator interface 128 includes or is configured as a controller that allows for controlling the operation or setting of one or more components of the harvester vehicle 100.

A crop harvesting device 114 is coupleable to the chassis 108. The crop harvesting device 114 can be configured to remove cotton from a field in some examples. The crop harvesting device 114 in one or more examples includes a header system 110 having one or more cotton stripper headers 112 operable to strip cotton during harvesting. However, other devices are capable of being coupled to the harvester vehicle, such as one or more cotton picking units, or another harvesting structure (e.g., corn head, or other crop heads). The crop harvesting device 114 has different configurations (e.g., sizes, dimensions, etc.) depending on the type of crop being harvested and the manner of removing the crop from the field. In various herein described implementations, the harvester vehicle 100 is a cotton stripper equipped with the crop harvesting device 114 that is adapted to remove, or strip, cotton from the plant (instead of picking cotton from the plants).

The header system 110 further includes a crop header component that operably harvests a crop from a target field, a hydraulic motor or electric motor (not shown), and one or more sensors. In the illustrated example, the crop header component includes the cotton stripper header 112 configured to strip cotton. For implementations of the header system 110 that include a hydraulic motor, a hydraulic pump on the harvester vehicle 100 can drive the hydraulic motor on the cotton stripper header 112. In these implementations, the hydraulic motor supplies the power to rotate a shaft that drives individual harvesting units, as well as cross augers that deliver cotton to the harvester vehicle 100. In other implementations, the electric motor supplies the power to rotate a shaft that drives individual harvesting units, as well as cross augers that deliver cotton to the harvester vehicle 100.

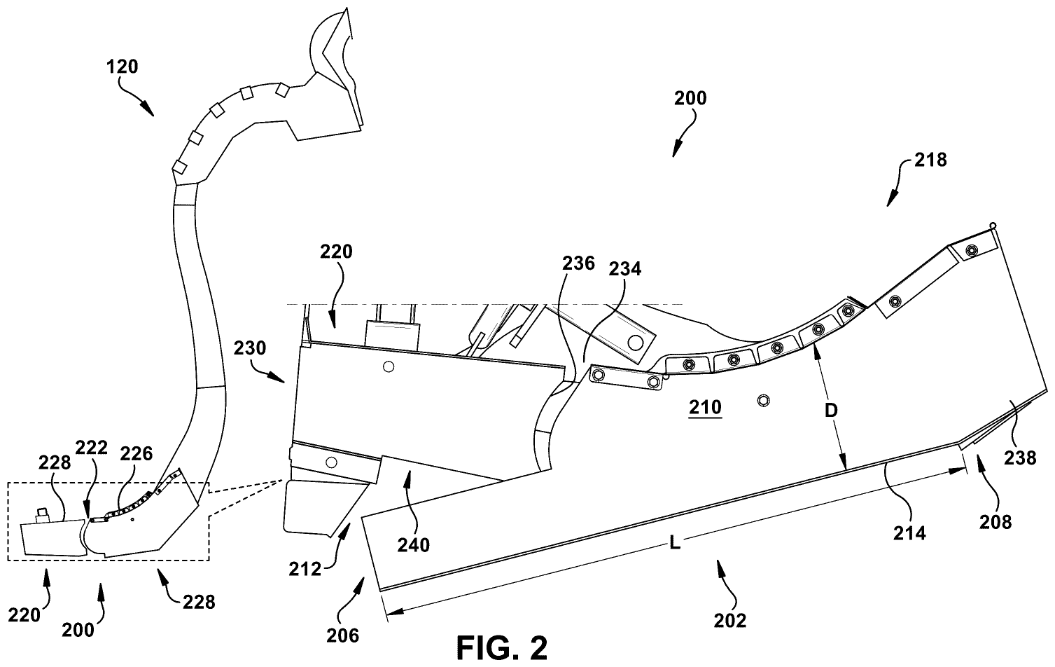

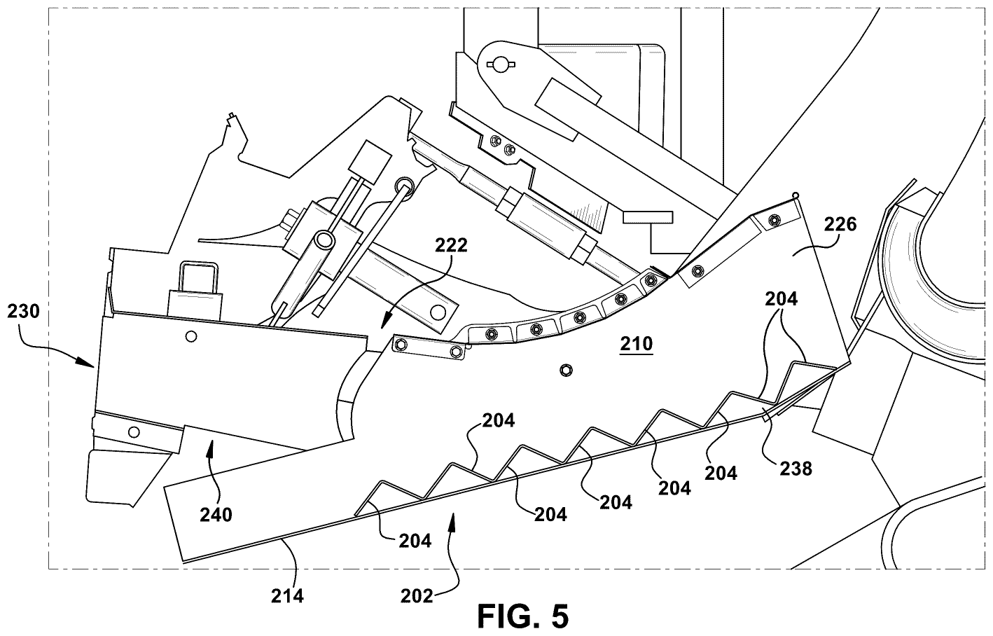

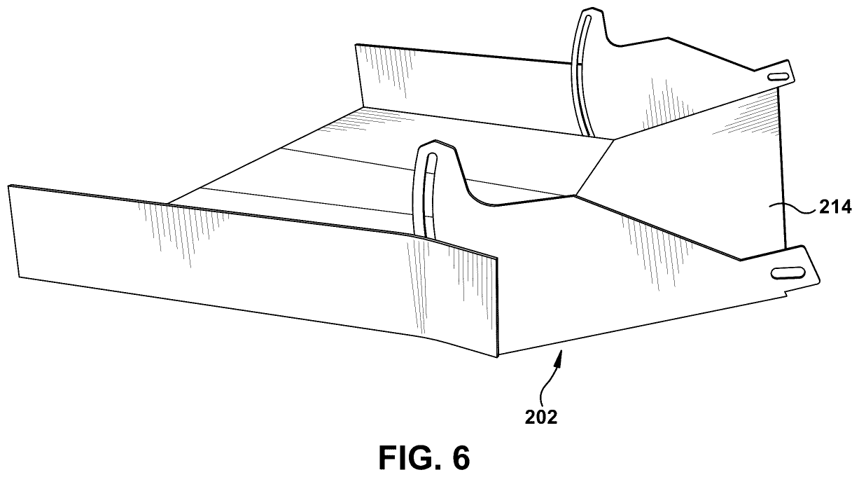

In some implementations, the harvester vehicle 100 includes an air system 120. The air system 120 in some examples includes a crop conveyor component that conveys the crop through the harvester vehicle 100, one or more sensors 160, and a crop conveyor device (e.g., one or more air ducts and an air flow generator). In some implementations as described in more detail herein, the crop conveyor component includes one or more air ducts 122 having a cotton stripper lower transition duct 200 (see FIGS. 2-7 and also referred to as a lower transition duct 200) configured to prevent unwanted material from entering the air system 120 when harvesting cotton, and with improved air flow, in particular, an improved cotton mass flow rate during harvesting. That is, one or more examples allow for separation of unwanted material (e.g., separation of green bolls and stones moving up towards the cleaning system) with increased cotton mass flow rate. As such, and for example, user modification to provide more cotton flow is not needed (e.g. removal of separating members).

In some implementations, the air system 120 is operably coupled to, and in communication with, the header system 110. In these implementations, the air duct 122 is coupled to, and aligned with the cotton stripper header 112, so that the cotton stripped by the cotton stripper header 112 can be transported into the harvester vehicle 100 (e.g., a cleaner) through the air ducts 122 of the air system 120 powered by air flow (e.g., an air generator). One implementation of the air system 120 is shown in FIG. 2, configured as a cotton air flow system having the lower transition duct 200 with improved operation. That is, increased cotton flow is provided while maintaining separation of unwanted or non-desired material (e.g., non-cotton material).

The one or more sensors 160 can be configured to monitor air flow and/or crop mass flow in the air ducts 122 of the air system 120. In some implementations, one or more of the sensors 160 can be positioned in the air ducts 122. As an example, the harvester vehicle 100, configured as a cotton stripper, includes a plurality of the sensors 160 (e.g., flow sensors) that are mounted across the width of the air ducts 122. In other implementations, one or more of the sensors 160 can be positioned adjacent the air ducts 122. As an example, the harvester vehicle 100, such as the cotton stripper, includes a plurality of mass flow sensors 160 that are mounted behind the air ducts 122 with one cotton mass flow sensor mounted per row unit. The air flow, and/or crop mass flow, can be monitored using various types of sensors.

In some implementations, the harvester vehicle 100 includes a cleaner system 130. In some examples, the cleaner system 130 includes a crop cleaner component that operably cleans the harvested crop, a hydraulic motor or electric motor (not shown), and one or more sensors. In some implementations, the crop cleaner component includes a cleaner 132 that is configured to clean cotton from the cotton stripper header 112 by removing trash and debris. For implementations of the cleaner system 130 that include a hydraulic motor, a hydraulic pump on the harvester vehicle 100 drives the hydraulic motor on the cleaner 132.

In some implementations, the cleaner system 130 is operably coupled to, and in communication with the header system 110 via the air system 120. In these implementations, the cleaner 132 is coupled to, and aligned with, the air duct 122 so that the cotton stripped by the cotton stripper header 112 can be transported into the cleaner 132 through the air ducts 122 of the air system 120 powered by air flow.

A crop receptacle 152 is coupleable to the air system 120 in various implementation. In one or more examples, the crop receptacle 152 is a module builder 150 having at least one baler belt (not shown). As an example, the module builder 150 can be used to build a module of the crop, such as a bale of cotton or hay/straw, etc. In other implementations, the crop may be ejected by the air system 120 into an internal hopper, and/or ejected from the harvester into an accompanying holding tank.

The harvester vehicle 100 further includes an accumulator system 140. The accumulator system 140 in some examples includes a crop accumulator component that operably, temporarily stores the harvested crop. In some implementations, the crop accumulator component includes an accumulator 142. The accumulator 142 is configured to receive cotton, or other crop, harvested by the cotton stripper header 112 or the cotton picking units 116.

In some implementations, the accumulator system 140 is operably coupled to, and in communication with the cleaner system 130. In these implementations, the harvested crop can be transported (e.g., powered by air flow from an air generator) from the cleaner 132 into the top of the accumulator 142 such that the accumulator 142 fills from the bottom up.

In various examples, a feeder 136 is also coupleable to the chassis 108. The feeder 136 can be configured to receive cotton, or other crop, from the accumulator 142. The feeder 136 includes a plurality of rollers configured to compress the cotton, or other crop, and transfer the cotton, or other crop, to the module builder 150 at a feed rate.

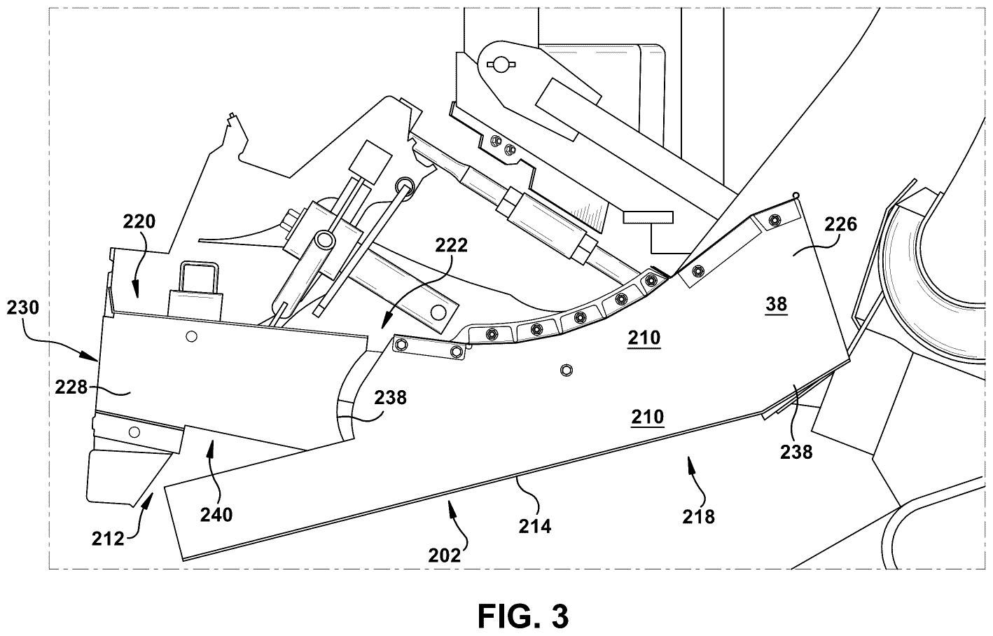

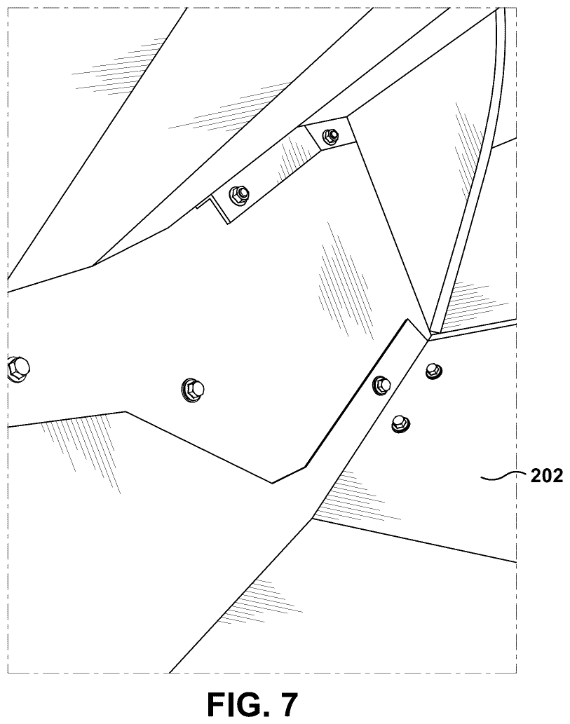

With particular reference to FIGS. 2-8, the air system 120 has the lower transition duct 200 that includes a rear separation duct panel 202 having a planar configuration to allow increased cotton flow through the lower transition duct 200, while also separating (e.g., blocking or preventing) unwanted or non-desired material (e.g., green bolls, rocks, etc. that are entrained by the harvested cotton mass) from passing through the lower transition duct 200. That is, the geometry of the rear separation duct panel 202 provides improved cotton mass flow rate while slowing down unwanted or non-desired material, which results in the unwanted or non-desired material being removed from the lower transition duct 200 as described in more detail herein. As can be seen (see FIG. 3), the rear separation duct panel 200 is flat or smooth along an inner or interior surface thereof (e.g., has flat or smooth walls defining the interior passageway).

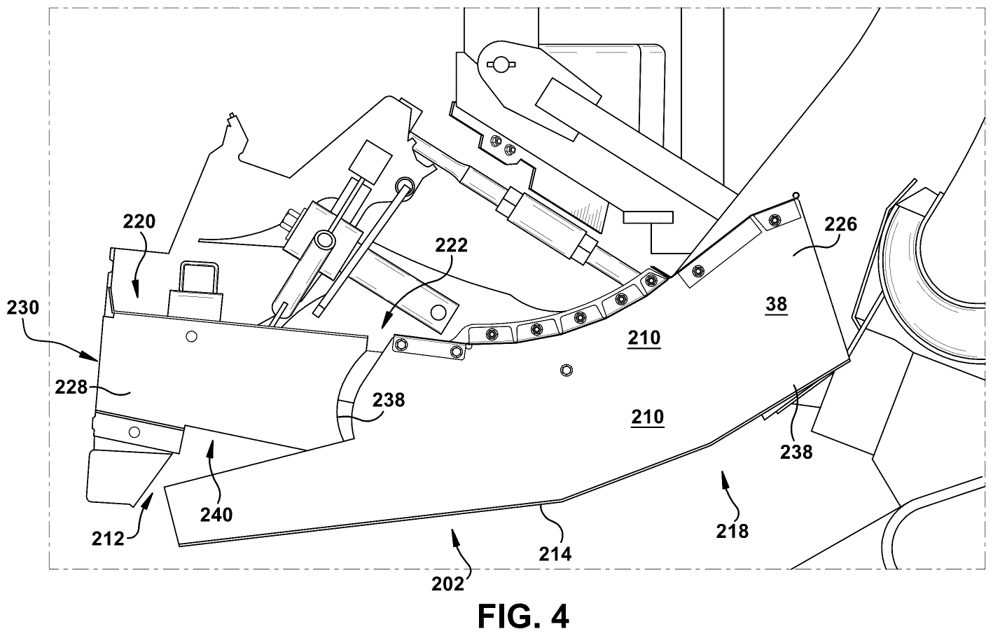

It should be noted that in some examples (see FIG. 5), a plurality of protruding members 204, illustrated as triangular baffles, are configured to deflect, check, or regulate flow or passage of the unwanted or non-desired material (e.g., that is heavier than the wanted material, namely cotton) from within the lower transition duct 200, such that the interior passageway of the lower transaction duct 200 is not smooth or flat along the surfaces, particularly the bottom and/or back inner wall. That is, the protruding members 204 further slow the unwanted or non-desired material as the unwanted or non-desired material passes into the lower transition duct 200 by making contact with the unwanted or non-desired material moving along a bottom interior surface of the lower transition duct 200 to thereby slow the unwanted or non-desired material and prevent the passage of the unwanted or non-desired material as described in more detail herein.

The protruding members 204 can include any type of obstructing members that have different configurations. For example, the protruding members 204 can have different shapes, sizes, etc. As such, the number, shape, size, spacing, orientation, arrangement, etc. of the protruding members 204 can be varied as desired or needed and is not limited to the number, shape, and arrangement illustrated in FIG. 5.

In the illustrated example, the protruding members 204 extend along an entire length of the rear separation duct panel 202. That is, the protruding members 204 extend along an entire length (entirety of the length) of a lower portion of the passageway 210 of the rear separation duct panel 202. It should be appreciated that the protruding members 204 can extend along a greater or lesser length of the rear separation duct panel 202, as well as along a greater or lesser length of the lower transition duct 200. For example, the protruding members 204 can be provided along higher or lower portions, or more forward or more rearward portions within the passageway 210.

In the various examples, the rear separation duct panel 202 extends longitudinally and generally parallel to an opposing side of the lower transition duct 200 to provide a passageway 210 with a constant cross-section (having a cross-section D) along substantially the entire length of the lower transition duct 200. That is, the planar rear separation duct panel 202 has a planar lower wall 214 (or floor) that extends along a length (L) to be linear from a front portion 206 to a rear portion 208 (having an angled lower portion (shorter than the planar lower wall 214) at a back end of the passageway 210 that has a slope that is different than a slope of the planar lower wall 214). As such, the linear configuration is provided from an opening 212 (where the unwanted or non-desired material is removed by the force of gravity and additional air flow is provided as described in more detail herein) to the cleaner 132 that is coupled to, and aligned with, the air duct formed by the lower transition duct 200, so that the cotton stripped by the cotton stripper header 112 can be transported into the cleaner 132 through the air ducts 122 of the air system 120 powered by air flow as described in more detail herein. In some examples (see FIG. 4), the planar lower wall 214 is defined by two planar sections that have different slopes (e.g., one section is slightly angled relative to the other section complimentary to an upper portion of the lower transition duct 200 to define a generally constant cross-section through the lower transition duct 200). That is, in some examples, the configuration (e.g., shaped and/or slope) of the rear separation duct panel 202 is complementary to (e.g., follows or matches the profile of) the upper curved area of the lower transition duct 200 to maintain the consistent or constant cross-section. Thus, in various examples, the configuration of the rear separation duct panel 202 provides a more constant cross-section across the flow path than a configuration having a varying cross-section (e.g., an angled floor configuration).

The lower transition duct 200 includes the rear separation duct panel 202 that has a generally linear passageway 210 along the lower transition duct 200. That is, in one or more examples, the lower transition duct 200 is configured having the rear separation duct panel 202 that is planar (e.g., having a flat surface) complementary to the surface of one or more of the other portions of the lower transition duct 200. As a result, a cross-section of the lower transition duct 200 is maintained constant throughout an extended or longer portion of the passageway 210, including along the entire rear separation duct panel 202 in some examples. This more constant cross-section of the passageway 210 allows for more material flow therethrough while still providing removal or separation of unwanted or non-desired material.

It should be noted that that the geometry of the rear separation duct panel 202 is configured to have the same geometry as a front or top portion of the lower transition duct 200 on an opposing portion of the passageway 210 in various examples. It should also be noted that the rear separation duct panel 202 in various examples can have a different angle than shown, namely, a different slope that is greater or less than illustrated. In various examples, the rear separation duct panel 202 is configured to have the same slope along the entire length of the rear separation duct panel 202.

As can be seen, the lower transition duct 200 includes a first portion 218 and a second portion 220. The first and second portions 218, 220 are formed from hollow bodies 226, 228 (e.g., tubular and/or hollow members or regions) in some examples that define the passageway 210 therethrough. The second portion 220 is configured as a lower portion that receives inflow of material from an opening 230 (e.g., stripped cotton from a cross-auger). For example, the opening 230 of the second portion 220 is configured to communicatively couple with the cross-auger of the cotton stripper to receive cotton material and non-cotton material. The first portion 218 includes the rear separation duct panel 202 and separates the unwanted or non-desired material from the harvested cotton as described in more detail herein.

In the illustrated example, a gap 222 is provided between the first portion 218 and the second portion 220 that allows, in part, movement between the first portion 218 and the second portion 220 (e.g., the second portion 220 pivots with respect to the first portion 218 to be oriented towards the ground). In some examples, as can be seen in FIG. 2, at least a portion of the gap 222 is covered or sealed such that no (or a reduced amount of) exposed space is provided between the first portion 218 and the second portion 220. That is, the leading end of the second portion 220 is engaged with the trailing end of the first portion 218 such that only the opening 212 is provided as described in more detail herein. The closing of the gap 222 can be provided in any suitable manner, such as by using a sealing member (e.g., a flexible sealing member 234 or a scaling flap), extending along a length of the second portion 220 towards the first portion 218, etc.

Thus, the second portion 220 includes an inlet defined by the opening 230 that is configured to receive stripped cotton (and non-cotton material) and an outlet 236 that is configured to output the stripped cotton that includes the unwanted or non-desired material. That is, cotton material and non-cotton material passes through the second portion 220 and into the first portion during cotton stripping operation. The non-cotton material, such as the unwanted or non-desired material, is then removed from the lower transition duct 200 by the force of gravity. For example, the unwanted or non-desired material is blocked or slowed by the angled planar lower wall 214 of the rear separation duct panel 202 and then moves backward and falls out of the opening 212 at a front of the rear separation duct panel 202 and below the second portion 220. That is, the force of gravity causes the slowed and/or blocked non-cotton material to flow downward and exit the lower transition duct 200 through the opening 212.

In one or more examples, the second portion 220 has an open floor portion 240 that facilitates the exit and removal of the non-cotton material (and also allows suction air to be pulled in beneath the flow of cotton in addition to the header opening). That is, the second portion 220 has an opening in the floor portion or has part or all of the floor portion removed to expose the passageway therein to the opening 212. As can be seen, in the illustrated example, the rear separation duct panel 202 extends below the open floor portion 240 (in various examples the planar lower wall 214 has a length that is greater than a length of an upper wall of the first portion 218), such that the non-cotton material that reverses flow down the rear separation duct panel 202 is allowed to pass through or by the open floor portion 240 and then through the opening 212, thereby being expelled from the lower transition duct 200. The overlap of the rear separation duct panel 202 below the open floor portion 240 also provides an additional incoming air flow (e.g., suction air) that facilitates the movement of the cotton material up the lower transition duct 200. That is, the open floor portion 240 allows additional air flow into the passageway 210 that provides increased suction within the passageway 210 in some examples.

It should be noted that the amount of overlap of the end of the rear separation duct panel 202 and the open floor portion 240 can be varied as desired or need to thereby change the size of the opening 212. In some examples, the size of the opening 216 is also adjustable by moving the rear separation duct panel 202 and/or changing and angle or slope of the rear separation duct panel 202. As such, different sized material can be removed from the passageway 210 as flow is provided through the lower transition duct 200. That is, heavier unwanted or non-desired material falls back down the passageway 210 and through the opening 212, while lighter stripped cotton that has been harvested continues upward along the passageway 210.

Thus, the lower transition duct 200 has a less restrictive flow through the passageway 210 while still removing unwanted or non-desired material from the harvested cotton. For example, as described in more detail herein, more material flow is provided through the passageway 210 by the geometry of the lower transition duct 200 (including a longer constant cross-section). It should be noted that while in some configurations, the rear separation duct panel 202 is provided with the protruding members 204, the rear separation duct panel 202 can be provided with other types of blocking or obstructing members or without any protruding members 204 as described herein. As such, it should be appreciated that one or more features described herein can be combined with one or more other features as desired or needed.

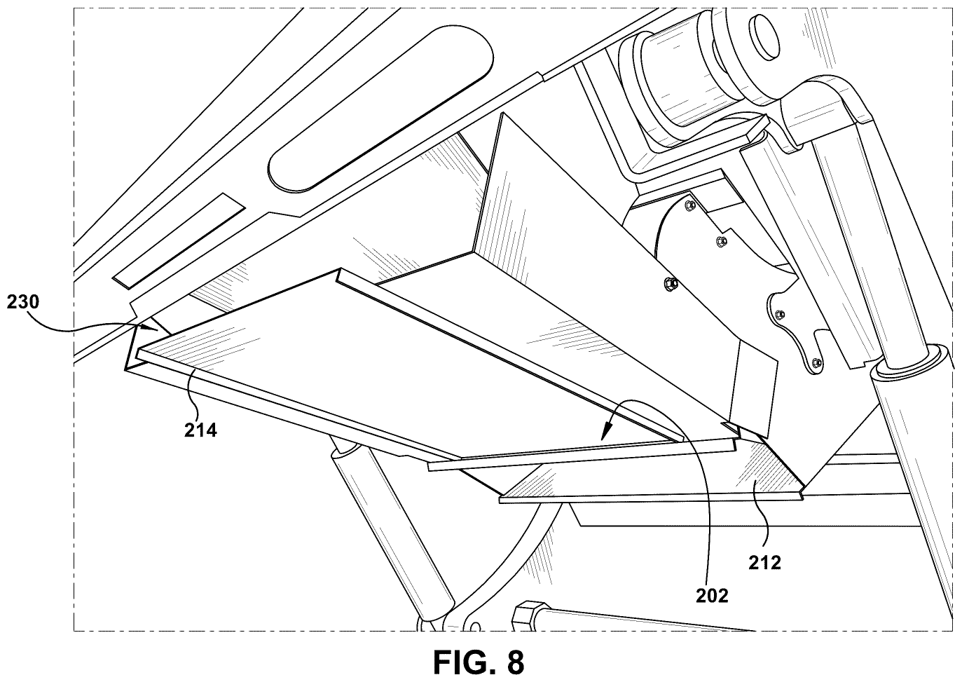

FIG. 9 is a component diagram illustrating an airflow system with a lower transition duct configured according to an implementation. In the implementation illustrated, an air duct for a cotton stripper comprises a first portion 218 having a rear separation duct panel 202 configured to separate non-cotton material from cotton material, wherein the rear separation duct panel 202 has a planar lower wall 214. The air duct further comprises a second portion 220 movably coupled with the first portion 218 at a joint forming a gap 222 between the first and second portions 218, 220, wherein the second portion has an opening 230 configured as an inlet that receives the cotton material and the non-cotton material into the air duct, wherein the second portion has a planar lower wall 215 extending from the joint forming the gap 222 between the first and second portions to the opening configured as the inlet, wherein a forward extent of the planar lower wall 214 of the first portion 218 ends at the gap 222 between the first and second portions 218, 220 without overlapping the planar lower wall 215 of the second portion 220. In accordance with an example, the planar lower wall 214 of the first portion 218 is pivotally connected on a first end 211 thereof with the rear separation duct panel 202, wherein pivoting a second end 213 of the planar lower wall 214 of the first portion 218 opposite the first end 211 thereof in a direction away from the gap 222 at the joint provides an expulsion opening 217 configured to permit the non-cotton material separated from the cotton material to be expelled from the air duct and to permit air to enter into the air duct. In accordance with an example, the planar lower wall 215 of the second portion 220 is substantially planar and without protuberances extending into the air duct. In accordance with an example, the planar lower walls 214, 215 of the first and second portions 218, 220 are substantially planar, wherein the first and second planar lower walls 214, 215 of the first and second portions 218, 220 lie in a common plane 219 for the second end 213 of the planar lower wall 214 of the first portion 218 disposed in a direction towards the gap 222 between the first and second portions 218, 220.

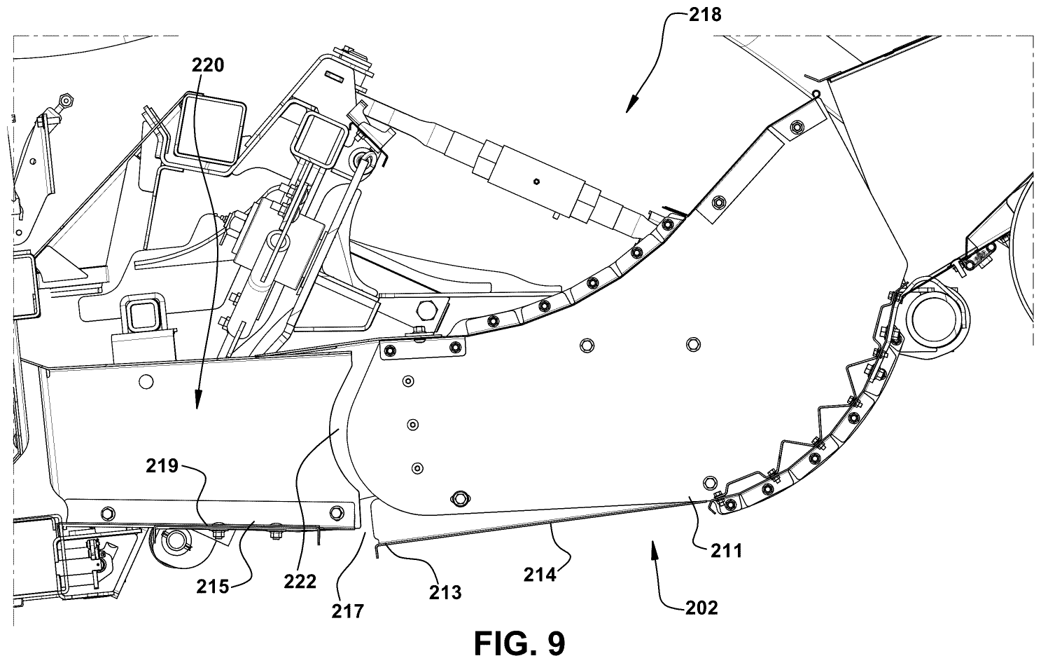

FIG. 10 is a component diagram illustrating an airflow system with a lower transition duct configured according to an implementation. In the implementation illustrated, an air duct for a cotton stripper comprises a first portion 218 having a rear separation duct panel 202 configured to separate non-cotton material from cotton material, wherein the rear separation duct panel 202 has a planar lower wall 214. The air duct further comprises a second portion 220 movably coupled with the first portion 218 at a joint forming a gap 222 between the first and second portions 218, 220, wherein the second portion has an opening 230 configured as an inlet that receives the cotton material and the non-cotton material into the air duct, wherein the second portion 220 has a planar lower wall 215 extending from the joint forming the gap 222 between the first and second portions to an open floor portion 221 that begins at a forward extent of the planar lower wall of the second portion. In accordance with an example, the planar lower wall 215 of the second portion 218 is pivotally connected on a first end thereof with the second portion 220, wherein pivoting a second end of the planar lower wall 215 of the second portion 220 opposite the first end thereof in a direction away from the second portion 220 provides a first expulsion opening 223 configured to permit the non-cotton material separated from the cotton material to be expelled from the air duct. In accordance with an example, the planar lower wall 214 of the first portion 218 is pivotally connected on a first end thereof with the rear separation duct panel 202, wherein pivoting a second end of the planar lower wall 214 of the first portion 218 opposite the first end thereof in a direction away from the joint forming the gap 222 provides a second expulsion opening 225 configured to permit the non-cotton material separated from the cotton material to be expelled from the air duct and to permit air to enter into the air duct.

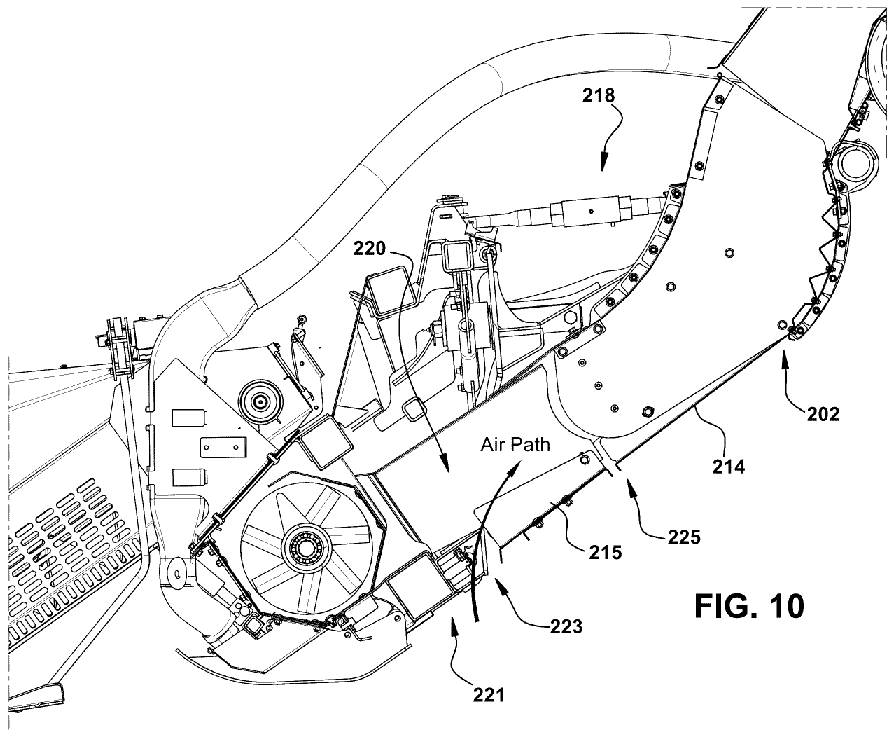

FIG. 11 is a component diagram illustrating an airflow system with a lower transition duct configured according to an implementation. In the implementation illustrated, an air duct for a cotton stripper comprises a first portion 218 having a rear separation duct panel 202 configured to separate non-cotton material from cotton material, wherein the rear separation duct panel 202 has a planar lower wall 214. The air duct further comprises a second portion 220 movably coupled with the first portion 218 at a joint forming a gap 222 between the first and second portions 218, 220, wherein the second portion 220 has an opening 230 configured as an inlet that receives the cotton material and the non-cotton material into the air duct, wherein the second portion has a planar lower wall 215 extending from the joint forming the gap 222 between the first and second portions to an open floor portion 221 that begins at a forward extent of the planar lower wall of the second portion. In accordance with an example, the planar lower wall 215 of the second portion 218 carries a crop deflection member 231 extending from the planar lower wall 214 of the second portion 218 in a direction away from the second portion 220, wherein the crop deflection member 231 is configured to provide a barrier to entry of associated crop and miscellaneous other materials into the open floor portion 221 of the second portion 220 for relative movement between the air duct and the associated crop in a direction of the crop deflection member 231 leading the open floor portion 221 towards the associated crop. In accordance with an example, the planar lower wall 215 of the second portion 220 is pivotally connected on a first end thereof with the second portion 220, wherein pivoting a second end of the planar lower wall of the second portion opposite the first end thereof in a direction away from the second portion provides a first expulsion opening 223 configured to permit the non-cotton material separated from the cotton material to be expelled from the air duct. In accordance with an example, the planar lower wall 214 of the first portion 218 is pivotally connected on a first end thereof with the rear separation duct panel, wherein pivoting a second end of the planar lower wall of the first portion opposite the first end thereof in a direction away from the joint provides a second expulsion opening 225 configured to permit the non-cotton material separated from the cotton material to be expelled from the air duct and to permit air to enter into the air duct.

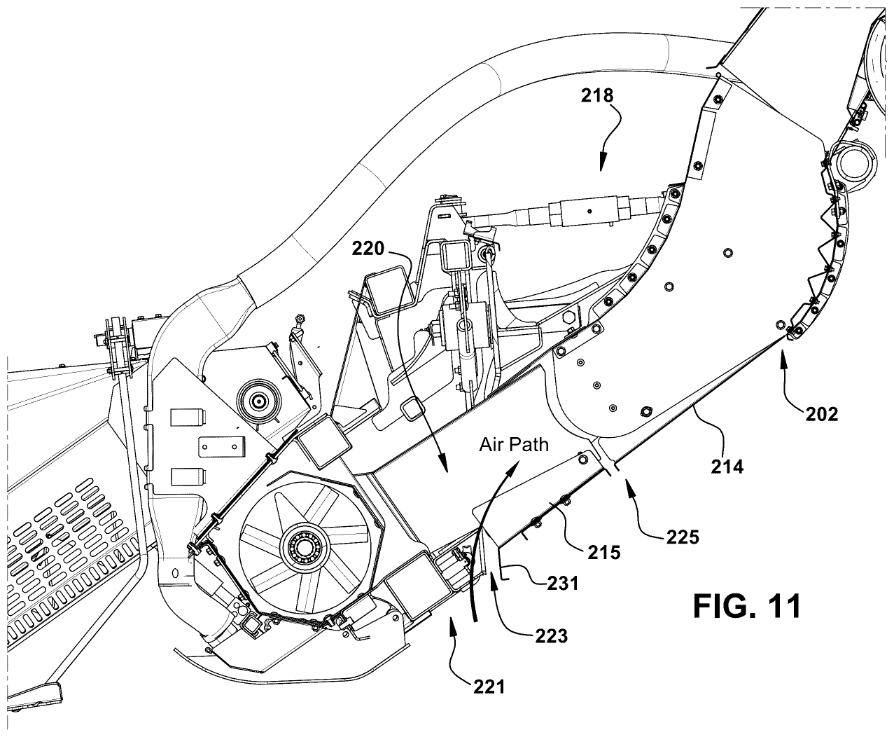

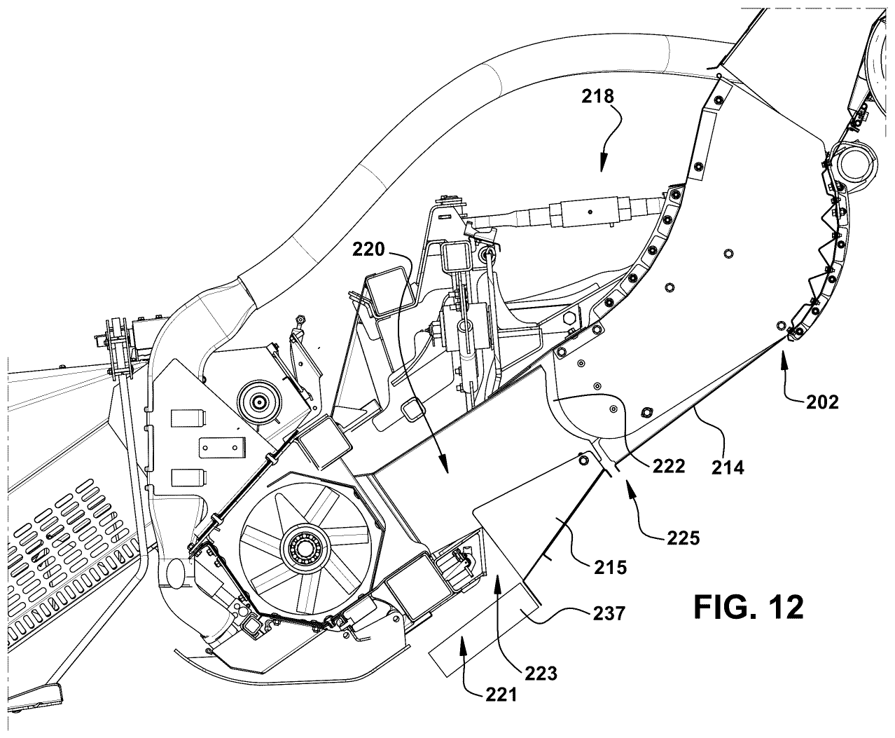

FIG. 12 is a component diagram illustrating an airflow system with a lower transition duct configured according to an implementation. In the implementation illustrated, an air duct for a cotton stripper comprises a first portion 218 having a rear separation duct panel 202 configured to separate non-cotton material from cotton material, wherein the rear separation duct panel 202 has a planar lower wall 214. The air duct further comprises a second portion 220 movably coupled with the first portion at a joint forming a gap 222 between the first and second portions 218, 220, wherein the second portion has an opening configured as an inlet that receives the cotton material and the non-cotton material into the air duct, wherein the second portion 220 has a planar lower wall 215 extending from the joint forming the gap 222 between the first and second portions to an open floor portion 221 that begins at a forward extent of the planar lower wall of the second portion. In accordance with an example, the planar lower wall 215 of the second portion 220 carries an arcuate crop shield member 237 extending from the planar lower wall of the second portion in a direction away from the second portion, wherein the arcuate crop shield member 237 is configured to permit the non-cotton material separated from the cotton material to be expelled from the air duct, together with any other debris including and in particular any larger solid objects such as rocks for example entering the inlet and entrained in the air flow carrying the cotton and non-cotton material. In accordance with an example, the arcuate crop shield member 237 also provides a barrier to entry of associated crop into the open floor portion 221 of the second portion for relative movement between the air duct and the associated crop in a direction of the arcuate crop shield member 237 leading the open floor portion towards the associated crop. In accordance with an example, the planar lower wall of the second portion is pivotally connected on a first end thereof with the second portion, wherein pivoting a second end of the planar lower wall of the second portion opposite the first end thereof in a direction away from the second portion provides a first expulsion opening 223 configured to permit the non-cotton material separated from the cotton material to be expelled from the air duct. In accordance with an example, the planar lower wall of the first portion is pivotally connected on a first end thereof with the rear separation duct panel, wherein pivoting a second end of the planar lower wall of the first portion opposite the first end thereof in a direction away from the joint provides a second expulsion opening 225 configured to permit the non-cotton material separated from the cotton material to be expelled from the air duct and to permit air to enter into the air duct.

FIG. 12A is a component diagram illustrating an airflow system with a lower transition duct configured according to an implementation. In the implementation illustrated, an air duct for a cotton stripper comprises a first portion as described above having a rear separation duct panel configured to separate non-cotton material from cotton material, wherein the rear separation duct panel has a planar lower wall, all generally as described above. The air duct further comprises a second portion movably coupled with the first portion at a joint forming a gap between the first and second portions wherein the second portion has an opening configured as an inlet that receives the cotton material and the non-cotton material into the air duct, all generally as described above. The second portion has a planar lower wall 215 extending from the joint forming the gap between the first and second portions to an open floor portion that begins at a forward extent of the planar lower wall of the second portion. In accordance with an example, the planar lower wall 215 of the second portion carries an arcuate crop shield member 237 extending from the planar lower wall of the second portion in a direction away from the second portion, wherein the arcuate crop shield member 237 is configured to permit the non-cotton material separated from the cotton material to be expelled from the air duct, together with any other debris entering the inlet and entrained in the air flow carrying the cotton and non-cotton material. In accordance with an example, the arcuate crop shield member 237 also provides a barrier to entry of associated crop into the open floor portion of the second portion for relative movement between the air duct and the associated crop in a direction of the arcuate crop shield member 237 leading the open floor portion towards the associated crop. In accordance with an example, the arcuate crop shield member 237 is pivotally connected on a first end thereof with appropriate support structure, wherein pivoting a second end of the crop shield member 237 opposite the first end thereof in a downward direction provides an expulsion opening 242 configured to permit the non-cotton material separated from the cotton material to be expelled from the air duct. In accordance with an example, a planar lower wall 238 of the crop shield member 237 has a generally triangular flat floor wherein outer ends 241, 243 of the crop shield member 237 are bent downwardly along crease lines 251, 253 to define a generally downwardly directed “V” shaped leading edge 255 of the crop shield member 237. In this manner the expulsion opening 242 has a generally non-rectangular overall shape that is particularly configured to permit non-cotton material having a wide range of sizes separated from the cotton material to be readily expelled from the air duct, wherein smaller-sized non-cotton materials may be expelled generally at the center region of the expulsion opening 242 while larger sized non-cotton materials such as larger solid objects including rocks for example may be expelled to the left and right as viewed in FIG. 12A, and particularly readily at the outer ends 241, 243 where the expulsion opening 242 is generally larger. The crop shield member 237 having a generally triangular shape wherein outer ends 241, 243 are bent downwardly along crease lines 251, 253 to define a generally downwardly directed “V” shaped leading edge 255 thereby defining a generally non-rectangular expulsion opening 242 has many advantages including the ability to both permit non-cotton material having a wide range of sizes separated from the cotton material to be readily expelled from the air duct, while also helping to prevent substantial loss of suction within the air duct overall such as might occur for example for the expulsion opening being defined in a generally rectangular overall conformation. The crop shield member 237 having such a generally triangular shape wherein outer ends 241, 243 are bent downwardly along crease lines 251, 253 to define a generally downwardly directed “V” shaped leading edge 255 thereby defining a generally non-rectangular expulsion opening 242 offers a beneficial compromise between a first configuration having a large rectangular opening permitting large solid objects such as rocks to be expelled across the full width of the opening but at the cost of permitting substantial loss of suction within the air duct overall, and a second configuration having a small rectangular opening that prevents substantial loss of suction within the air duct but that traps large solid objects such as rocks within the air duct. In accordance with an implementation, the sizes and/or placements and/or arrangements of one or more of the planar lower wall 238, the crease lines 251, 253, the generally downwardly directed “V” shaped leading edge 255, and/or the generally non-rectangular expulsion opening 242 may be tunable based on the type of crop and/or the size of the one or more fans that are operated to create the suction force to permit large solid objects such as rocks to be expelled while also maintaining good suction within the air duct so that the harvested cotton may be accumulated without the unwanted or non-desired material.

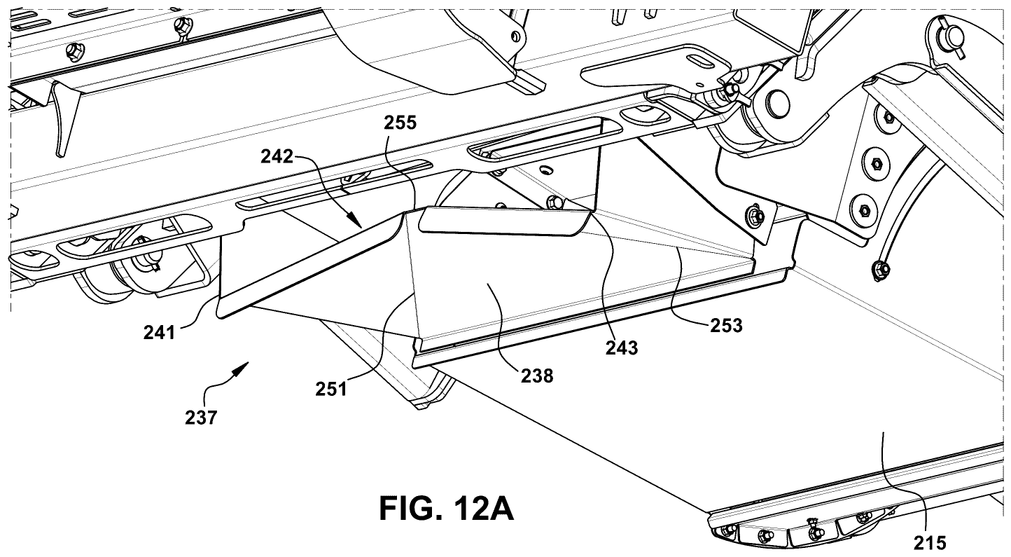

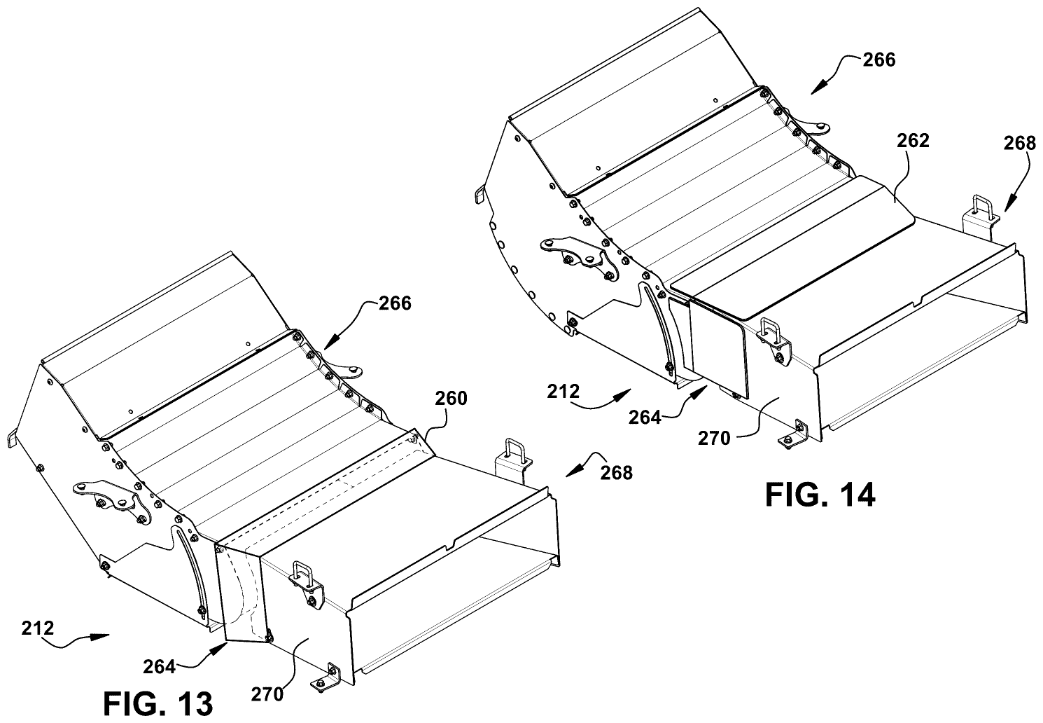

In some examples, the positive air supply provided by cotton flow accelerators allows for a more closed duct structure along the airflow path. That is, openings at different locations along the duct structure through which cotton is harvested can be closed as a sufficient airflow is provided with the combination of air paths as described herein. As noted above with reference to the structures shown in FIG. 2, the closing of the gap 222 can be provided in any suitable manner, such as by using a sealing member (e.g., a flexible sealing member 234 or a sealing flap), extending along a length of the second portion 220 towards the first portion 218, etc. in accordance with a further example, and as can be seen in FIGS. 13 and 14 a seal 260, 262 (e.g., a flexible sealing structure) is provided along the airflow path. More particularly, a gap 264 is provided between a first portion 266 and a second portion 268 of the cotton stripper lower transition duct 212 that allows, in part, movement between the first portion 266 and the second portion 268 (e.g., the second portion 268 pivots with respect to the first portion 266 to be oriented towards the ground). As can be seen, at least a portion of the gap 264 is covered or sealed by the seal 260, 262 such that no (or a reduced amount of) exposed space (e.g., closed opening) is provided between the first portion 266 and the second portion 268. That is, the leading end of the second portion 268 is engaged with the trailing end of the first portion 266, such that only the cotton inlet opening at the cross auger structure is provided.

The closing of the gap 264 can be provided in any suitable manner, such as by using any type of sealing member (e.g., a flexible sealing member or a sealing flap), extending along a length of the second portion 268 towards the first portion 266, etc. In the configuration illustrated in FIG. 13, the seal 260 comprises flexible flaps that pulls onto the receiving duct (the first portion 266) as the suction airflow is created as described in more detail herein. As can be seen, the seal 260 is a flexible sealing structure that allows movement between the first portion 266 and the second portion 268. That is, the seal 260 is configured to allow a receiving duct 270 of the second portion 268 to move upward and downward and pivot with lateral tilt header movement of the receiving duct 270.

Similarly, the seal 262 illustrated in FIG. 14 comprises a flexible or movable structure having flexible flaps that pull onto the receiving duct (the first portion 266) as the suction airflow is created as described in more detail herein. As can be seen, the seal 262 is a flexible sealing structure that allows movement between the first portion 266 and the second portion 268. That is, the seal 262 is configured to allow a receiving duct 270 of the second portion 268 to move upward and downward and pivot with lateral tilt header movement of the receiving duct 270 as a result of the material flexibility of the seal 262.

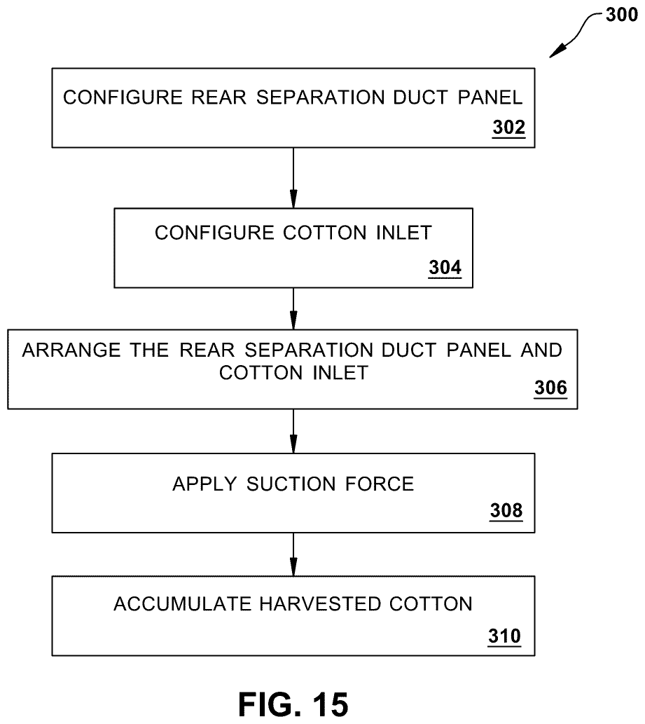

In various examples, the geometry of the lower transition duct 200 provides the lower transition (separation) duct with an extended or longer planar separation panel that improves flow rate capacity while also separating unwanted or non-desired material (e.g., provides slowdown and/or restriction of unwanted or non-desired material). A harvester with improved flow (e.g., improved harvesting capacity) is thereby provided, resulting in improved overall operation in some examples. For example, the geometry of the lower transition duct 200 allows more cotton flow while blocking separating unwanted or non-desired material as illustrated in the flowchart 300 of FIG. 15. That is, the flowchart 300 illustrates operations involved in configuring a lower transition duct in a cotton stripper according to one implementation. In some examples, the operations of the flowchart 300 are performed using one or more configurations described in more detail herein.

More particularly, the flowchart 300 commences at 302, which includes configuring a rear separation duct panel to have a longer planar surface. For example, the rear separation duct panel 202 is formed to have a longer floor or base that extends farther to and abuts or is adjacent to an entry area for the stripped cotton (e.g., abuts or is adjacent to and exit of one or more cross augers). In some examples, the herein described configurations move the suction point further forward in the duct, such as just behind the outlet of the header. Moreover, in some examples, one or more ‘dead spots’ are eliminated from the flow path. It should be noted that configuring the rear separation duct panel in some examples additionally includes removing impediments in the duct path (e.g., an upper ledge at an opening thereof).

At 304, a cotton inlet is configured to allow for incoming air flow (e.g., suction air) in a different direction and/or from a different location. For example, the second portion 220 is formed to have an open floor portion 240 that facilitates the exit and removal of the non-cotton material, as well as provide a secondary flow of air into the passageway 210. In some examples, the second portion 220 is manufactured with an opening that defines the open floor portion 240. In other examples, an opening is cut into the second portion 220 to form the open floor portion 240.

At 306, the configured rear separation panel and the configured cotton inlet are arranged to facilitate the cotton stripping operation as described in more detail herein. For example, the rear separation duct panel 202 is positioned such that an end thereof extends below the open floor portion 240, so that the non-cotton material that reverses flow down the rear separation duct panel 202 is allowed to pass through or by the open floor portion 240 and then through the opening 212, thereby being expelled from the lower transition duct 200, while providing incoming air flow in a different direction (e.g., from the bottom or floor of the lower transition duct 200). That is, the first and second portions 218, 220 are coupled and/or arranged such that rear separation duct panel 202 provide the opening 212 as described in more detail herein. In one or more examples, with the configured rear separation duct panel 202, operator adjustments are minimized or eliminated.

At 308, a suction force is applied to harvest stripped cotton through the lower transition duct. For example, one or more fans are operated to create a suction force that causes the harvested cotton (that includes the unwanted or non-desired material) to pass into the lower transition duct 200, wherein the harvested cotton is accumulated at 310. As described herein, the non-cotton material is also removed.

Thus, various examples provide improved harvester flow, including increased throughput (e.g., maximized throughput) while removing unwanted or non-desired material. As such, more cotton can be harvested in a shorter period of time with less likelihood of delays due to blockage from the unwanted or non-desired material or other issues (e.g., plugging issues) in various examples. One or more examples can provide one or more of:
1. Eliminating protruding members on a back wall of the lower transition duct 200.
2. Eliminating a dead zone on the lower back wall, such as by providing a consistent cross-section from the nozzle forward.
3. Moving the ‘threshold of active suction’ in this duct forward, much closer to the exit of the cross auger.
4. Creating an ‘active air floor’ by pulling air in from just beneath the cross auger opening, which effectively substantially lowers the floor that is just behind the cross auger opening.
5. Making separation as good as possible by creating a more significant turn in the duct, but only to the point that the cotton stays along the upper/front wall of the separation duct and minimizes impingement of cotton against back wall. Trajectory of the cotton as it gets flung off the cross auger is toward the upper surface of the separation duct. Ideally, significantly heavy objects will fall out of this trajectory as these objects traverse rearward.

In one or more examples, the lower transition duct 200 is able to handle the maximum throughput while still offering as much separation (e.g., separation of unwanted material) as possible, with little to no adjustment by the operator.

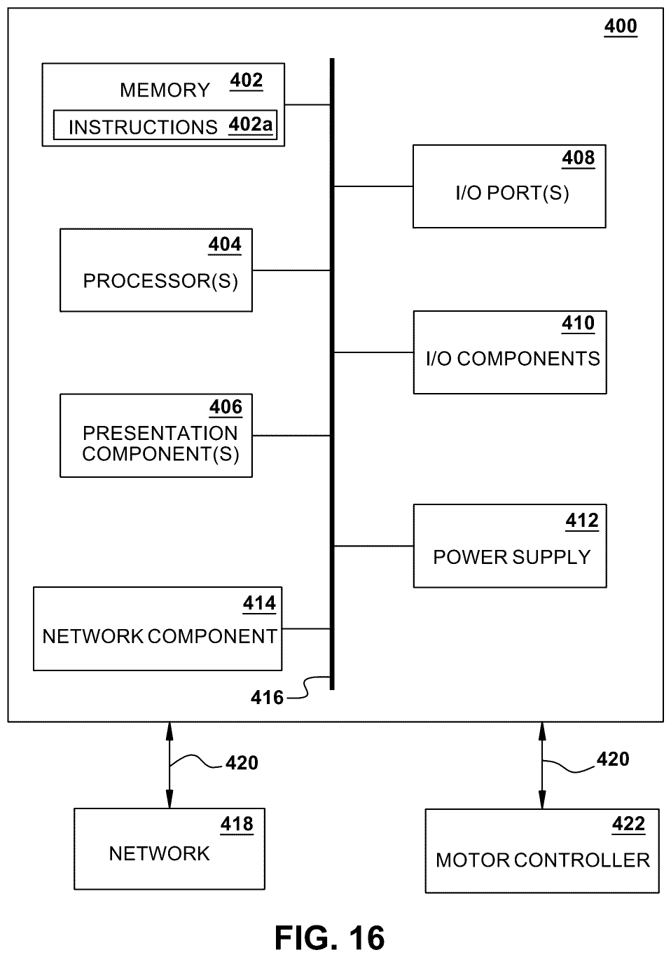

With reference now to FIG. 16, a block diagram of a computing device 400 suitable for implementing various aspects of the disclosure as described (e.g., operations or functions of the operator interface 128 or controller thereof). For example, in operation, the computing device 400 is operable with a motor controller 422 to control operation (e.g., suction force) of one or more motors that cause cotton material to be harvested. FIG. 16 and the following discussion provide a brief, general description of a computing environment in/on which one or more or the implementations of one or more of the methods and/or system set forth herein may be implemented. The operating environment of FIG. 16 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

In some examples, the computing device 400 includes a memory 402, one or more processors 404, and one or more presentation components 406. The disclosed examples associated with the computing device 400 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 15 and the references herein to a “computing device.” The disclosed examples are also practiced in distributed computing environments, where tasks are performed by remote-processing devices that are linked through a communications network. Further, while the computing device 400 is depicted as a single device, in one example, multiple computing devices work together and share the depicted device resources. For instance, in one example, the memory 402 is distributed across multiple devices, the processor(s) 404 provided are housed on different devices, and so on.

In one example, the memory 402 includes any of the computer-readable media discussed herein. In one example, the memory 402 is used to store and access instructions 402a configured to carry out the various operations disclosed herein. In some examples, the memory 402 includes computer storage media in the form of volatile and/or nonvolatile memory, removable or non-removable memory, data disks in virtual environments, or a combination thereof. In one example, the processor(s) 404 includes any quantity of processing units that read data from various entities, such as the memory 402 or input/output (I/O) components 410. Specifically, the processor(s) 404 are programmed to execute computer-executable instructions for implementing aspects of the disclosure. In one example, the instructions 402a are performed by the processor 404, by multiple processors within the computing device 400, or by a processor external to the computing device 400. In some examples, the processor(s) 404 are programmed to execute instructions such as those illustrated in the flow charts discussed herein and depicted in the accompanying drawings.

In other implementations, the computing device 400 may include additional features and/or functionality. For example, the computing device 400 may also include additional storage (e.g., removable and/or non-removable) including, but not limited to, magnetic storage, optical storage, and the like. Such additional storage is illustrated in FIG. 16 by the memory 402. In one implementation, computer readable instructions to implement one or more implementations provided herein may be in the memory 402 as described herein. The memory 402 may also store other computer readable instructions to implement an operating system, an application program and the like. Computer readable instructions may be loaded in the memory 402 for execution by the processor(s) 404, for example.

The presentation component(s) 406 present data indications to an operator or to another device. In one example, the presentation components 406 include a display device, speaker, printing component, vibrating component, etc. One skilled in the art will understand and appreciate that computer data is presented in a number of ways, such as visually in a graphical user interface (GUI), audibly through speakers, wirelessly between the computing device 400, across a wired connection, or in other ways. In one example, the presentation component(s) 406 are not used when processes and operations are sufficiently automated that a need for human interaction is lessened or not needed. I/O ports 408 allow the computing device 400 to be logically coupled to other devices including the I/O components 410, some of which is built in. Implementations of the I/O components 410 include, for example but without limitation, a microphone, keyboard, mouse, joystick, pen, game pad, satellite dish, scanner, printer, wireless device, camera, etc.

The computing device 400 includes a bus 416 that directly or indirectly couples the following devices: the memory 402, the one or more processors 404, the one or more presentation components 406, the input/output (I/O) ports 408, the I/O components 410, a power supply 412, and a network component 414. The computing device 400 should not be interpreted as having any dependency or requirement related to any single component or combination of components illustrated therein. The bus 416 represents one or more busses (such as an address bus, data bus, or a combination thereof). Although the various blocks of FIG. 16 are shown with lines for the sake of clarity, some implementations blur functionality over various different components described herein.

The components of the computing device 400 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of the computing device 400 may be interconnected by a network. For example, the memory 402 may be comprised of multiple physical memory units located in different physical locations interconnected by a network.

In some examples, the computing device 400 is communicatively coupled to a network 418 using the network component 414. In some examples, the network component 414 includes a network interface card and/or computer-executable instructions (e.g., a driver) for operating the network interface card. In one example, communication between the computing device 400 and other devices occurs using any protocol or mechanism over a wired or wireless connection 420. In some examples, the network component 414 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 420 may include, but is not limited to, a modem, a Network Interface Card (NIC), an integrated network interface, a radio frequency transmitter/receiver, an infrared port, a USB connection or other interfaces for connecting the computing device 400 to other computing devices. The connection 420 may transmit and/or receive communication media.

Although described in connection with the computing device 400, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. An air duct for a cotton stripper, the air duct comprising:
a first portion having a rear separation duct panel configured to separate non-cotton material from cotton material, the rear separation duct having a planar lower wall; and
a second portion movably coupled to the first portion, the second portion having an opening configured as an inlet that receives the cotton material and the non-cotton material, the second portion having an open floor portion,
wherein the planar lower wall of the rear separation duct panel extends to overlap with at least part of the open floor portion.

2. The air duct of claim 1, wherein the rear separation duct panel overlaps below the open floor portion to form an opening configured to expel the non-cotton material and define an air flow passage into the first and second portions.

3. The air duct of claim 1, wherein the planar lower wall extends along an entirety of a lower surface of the rear separation duct panel and defines a flat interior passageway along a lower surface of the air duct.

4. The air duct of claim 1, wherein the first portion comprises a passageway therethrough, and the planar lower wall is complementary with an upper wall to define a constant cross-section throughout the passageway.

5. The air duct of claim 1, wherein the planar lower wall is angled from a front to a back of the first portion.

6. The air duct of claim 1, wherein the planar lower wall is flat along an entirety of a length thereof from a front end of the planar lower wall to a back end of the planar lower wall.

7. The air duct of claim 1, wherein the planar lower wall has a length that is greater than a length of an upper wall of the first portion.

8. The air duct of claim 1, wherein the first portion comprises a passageway therethrough, and the planar lower wall comprises a plurality of protruding members extending into the passageway.

9. The air duct of claim 8, wherein the plurality of protruding members comprises triangular-shaped baffles configured as obstructing members.

10. The air duct of claim 1, wherein the first and second portions comprise first and second bodies having hollow regions defining complementary passageways, wherein the first portion is coupled to the second portion having a gap therebetween.

11. The air duct of claim 10, further comprising a sealing member covering the gap.

12. The air duct of claim 1, wherein the opening of the second portion is configured to communicatively couple with a cross-auger of a cotton stripper to receive the cotton material and the non-cotton material.

13. The air duct of claim 1, wherein the first portion comprises a passageway therethrough and an angled lower portion at a back end of the passageway that has a slope that is different than a slope of the planar lower wall.

14. The air duct of claim 13, wherein the angled lower portion is planar and shorter than the planar lower wall.

15. A harvester vehicle comprising:
a header system that includes a crop header component, wherein the crop header components comprises a cotton stripper header; and
an air system operably coupled to, and in communication with, the header system, the air system comprising a crop conveyor component that conveys crop through the harvester vehicle, wherein the crop conveyor component includes one or more air ducts having a cotton stripper lower transition duct comprising a rear separation duct panel having a planar lower wall that overlaps with an open floor portion of an inlet of the lower transition duct.

16. The harvester vehicle of claim 15, wherein the lower transition duct comprises a first portion having a rear separation duct panel configured to separate non-cotton material from cotton material, the rear separation duct including the planar lower wall, and a second portion movably coupled with the first portion, the second portion having an opening configured as the inlet that receives the cotton material and the non-cotton material, the second portion having the open floor portion.

17. The harvester vehicle of claim 16, wherein the rear separation duct panel overlaps below the open floor portion to form an opening configured to expel the non-cotton material and define an air flow passage into the first and second portions.

18. The harvester vehicle of claim 16, wherein the first portion comprises a passageway therethrough, and the planar lower wall is complementary with an upper wall to define a constant cross-section throughout the passageway, the planar lower wall is flat along an entirety of a length thereof from a front end of the planar lower wall to a back end of the planar lower wall, and the planar lower wall has a length that is greater than a length of an upper wall of the first portion.

19. The harvester vehicle of claim 15, wherein the lower transition duct comprises a passageway therethrough, and the planar lower wall comprises a plurality of protruding members extending into the passageway.

20. A method for configuring a lower transition duct in a cotton stripper, the method comprising:
configuring a rear separation duct panel to have a planar lower wall;
configuring a cotton inlet to have an open floor portion, the cotton inlet capable of receiving cotton material and non-cotton material; and
arranging the rear separation duct panel and the cotton inlet such that the planar lower wall of the rear separation duct panel extends to overlap with at least part of the open floor portion.
